(19) United States
(12) Patent Application Publication
(10) Pub. No.: US 2026/0303561 A1
(43) Pub. Date: Oct. 1, 2026

(54) SYSTEM AND METHODS FOR SECURED COMMUNICATIONS

(71) Applicant: VRAXON, LLC, Garland, TX (US)

(72) Inventor: Michael Myers, Garland, TX (US)

(21) Appl. No.: 19/656,297

(22) Filed: Apr. 23, 2026

(51) Int. Cl. H04L 51/234; H04L 9/40

(52) U.S. Cl. CPC H04L 51/234; H04L 63/0428; H04L 63/0861

(57) ABSTRACT

Computer-implemented systems and methods of secured communications performed by a sender's device, a recipients device, and/or an account registry. The disclosed systems and methods may perform user verification, device verification, and data encryption.

### TECHNICAL FIELD

This disclosure relates to the fields of data security, anti-spoofing, and electronic identity verification.

### BACKGROUND

Data security is important for protecting people's privacy and accounts from outsiders, particularly for sensitive data, such as bank account credentials, health records, classified documents, or trade secrets. Some attackers who seek that sensitive information do so through spoofing. Spoofing is the impersonation of legitimate people or devices, which leads users to mistakenly believe that the attacker can be trusted. Software exists to help detect spoofing, but that software often has holes, and either filters out legitimate communications or misses illegitimate communications.

Attempts to detect spoofing are becoming harder as spoofing becomes more sophisticated. By using large language models (LLMs) and other machine-learning algorithms, attackers can make their communications look closer and closer to legitimate messages. If a person received an illegitimate text message from an attacker, the person used to be able to call the phone number and determine that the recipient phone number is illegitimate based on, for example, no answer to the phone call or a static and obvious automated voice on the other end of the line. But, through the use of more sophisticated algorithms, an automated voice can be dynamic, and can sound like a legitimate user (e.g., AI voice deepfakes). Furthermore, the texts, emails, and other communications can appear more like they are coming from a legitimate source (e.g., social engineering fraud). To avoid being scammed, many people refuse to provide information to legitimate sources, such as bank information to a bank, or reimbursement to a friend.

There is a need for improving security of communications between devices in a network and for increasing trust in those communications. Those types of improvements would benefit people and businesses who communicate with each other, particularly where data security is more critical. Those types of improvements, therefore, are desirable for companies who have an ability to implement those security measures for those people and businesses (e.g., phone companies, banks, credit card companies).

### SUMMARY

Novel aspects of the disclosure are directed to computer-implemented methods and systems for secured communications.

One or more of the disclosed embodiments may include a method performed by a device of a recipient user that comprises receiving an encrypted digital passport from an account registry, wherein the digital passport includes a message from a sender user, an identification of the sender user, and an authentication of the identity of the sender user; decrypting, using a decryption algorithm that is specific to the recipient's device, the encrypted digital passport; deriving, from the decrypted digital passport, the message from the sender user; deriving, from the decrypted digital passport, the authentication of the identity of the sender user; requesting biometric data from the recipient user; confirming the identity of the recipient user by comparing the received biometric data with biometric data that is stored on the recipient's device; presenting, based on the confirmation of the identity of the recipient user, the message from the sender user; and transmitting a confirmation that the recipient user viewed the message.

One or more of the disclosed embodiments may include a method performed by an account registry that conveys encrypted messages, the method comprising: receiving, from a device of a sender, a message, an identity of the sender, and an indication of a recipient user as a target for the message; authenticating the sender's identity using a reference table at the account registry; combining the message, the sender's identity, and the authentication of the sender's identity into a digital passport; encrypting the digital passport using an encryption key associated with a device of the recipient user; and transmitting, to the recipient's device, the encrypted digital passport.

One or more of the disclosed embodiments may include a method performed by a device of a sender user, the method comprising: receiving, from the sender user, a request to initiate a call with a recipient user, a reason for the call, and biometric data of the sender user; confirming an identity of the sender user by comparing the received biometric data with biometric data that is stored on the sender's device; encrypting the reason for the call; based on the confirming the identity of the sender user, transmitting the encrypted reason for the call and an identification of the recipient user to an account registry; receiving, from a device of the recipient user, a confirmation that the recipient user viewed the reason for the call.

### BRIEF DESCRIPTION OF THE DRAWINGS

For a more complete understanding of the novel aspects of this disclosure and its advantages, reference is now made to the following description and the accompanying drawings, in which:

FIG. 1 is a schematic diagram of a system for secured communications according to an illustrative embodiment;

FIG. 2 is a schematic diagram of a computing device usable in a system for secured communications according to an illustrative embodiment;

FIG. 3 is a schematic diagram of a server usable in s system for secured communications according to an illustrative embodiment;

FIG. 4 is a flowchart of steps for performing a secured communication according to one or more illustrative embodiments;

FIG. 5 is a flowchart of steps performed by an account registry in facilitating a secured communication according to one or more illustrative embodiments;

FIG. 6 is a flowchart of steps performed by a recipient's device according to one or more illustrative embodiments; and

FIG. 7 is a flowchart of steps performed by a sender's device in facilitating a secured call according to one or more illustrative embodiments.

### DETAILED DESCRIPTION

The disclosed systems and methods may improve data security by eliminating the effect of AI deepfakes, social engineering fraud, or other types of spoofing or other data-security vulnerabilities. The systems and methods may do that, for example, through a mutual biometric handshake, or through the use of a known and trusted intermediate device. A known and trusted intermediate device may, for example, confirm the identity of a device sending a message based on IP address and a biometric confirmation of the sender and sender's device. A known and trusted intermediate device may also, for example, ensure that the message is only opened by the intended recipient, based on IP address and biometric confirmation for the recipient and recipient's device.

In some embodiments, the systems and methods may improve security by performing steps at the kernel (operating system) layer instead of performing functions, for example, at the application layer. For example, the systems and methods may include confirming biometric data or decrypting data through operating-system functions rather than through functions performed by third-party or cloud-based applications.

In some embodiments, the systems and methods may improve trust in a communication by providing confirmations at various steps of the process. For example, a system may confirm to a recipient that the identity of a sender has been verified, and what the nature of the communication is; and the system may confirm to the sender that the intended recipient received and viewed the message.

In some embodiments, the systems and methods involve facilitating a phone call such that both parties know that they are speaking with a human user who is who they claim to be. For example, through registering with an intermediate device (e.g., an account registry), the identity of a device can be verified; and through biometric confirmation, the person who is accessing the device can be verified. An account registry may be operated and managed, for example, by a bank, a credit card company, or a phone company who aggregates large numbers of customers for registration and verification. In some embodiments, a software platform can implement the disclosed methods or systems.

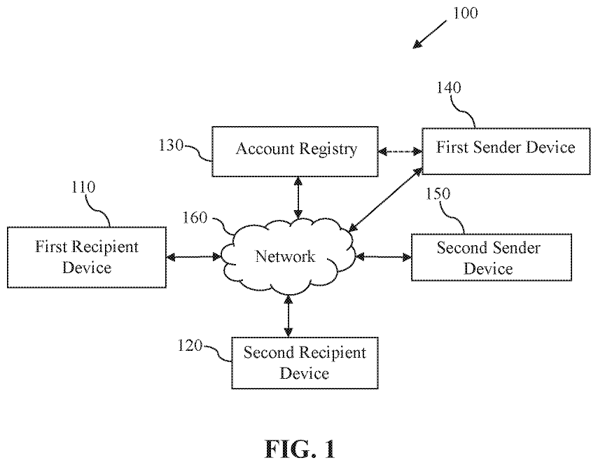

Turning to the figures, FIG. 1 is a diagram 100 that depicts an overview of one or more embodiments. The diagram 100 includes a first recipient device 110, a second recipient device 120, an account registry 130, a first sender device 140, a second sender device 150, and a network 160.

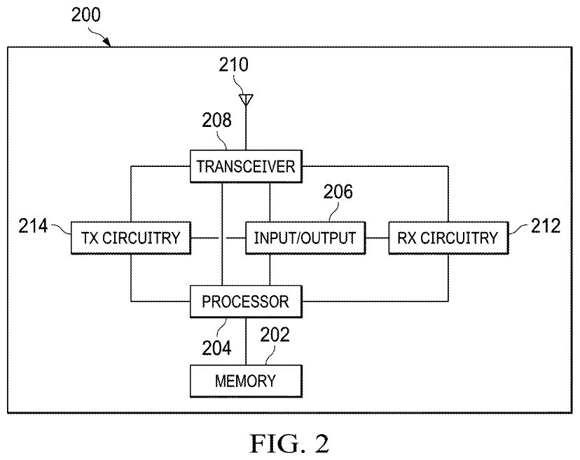

The devices 110, 120, 140, and 150 represent electronic devices—such as smart phones, laptop computers, desktop computers, or tablets—that are associated with a recipient or sender of a communication. A device may be “associated” with a person if the device is operated by or at the direction of that person, if the device is registered to that person, or if the device is logged into an account registered to that person. An example of a suitable electronic device is shown and described in more detail in FIG. 2, below. The devices are connected through wired or wireless connections to the network 160. The network 160 is a way of connecting the devices, such as through WAN, LAN, the Internet, or cell phone networks (e.g., 5G or 4G LTE-based networks).

The account registry 130 is at least one database and/or server that stores account information for user devices and facilitates secured communications between devices. The account registry 130 may comprise many databases and/or servers. In some embodiments, the account registry 130 is centralized. In some embodiments, the account registry 130 may function as a known and trusted intermediate device between other devices 110, 120, 140, 150 on the network 160.

The account registry 130 can include a cloud-type server, for example a server operated by a third-party cloud provider like AWS™. The account registry 130 may host an application that connects the devices 110, 120, 140, and 150. For example, the account registry 130 may receive a message from a sender's device, may confirm the identity of the sender's device through the use of a reference table, may compile the message and the confirmation of the identity of the sender into a digital passport, may encrypt the digital passport using an encryption key from another reference table, and may transmit the digital passport to a recipient's device.

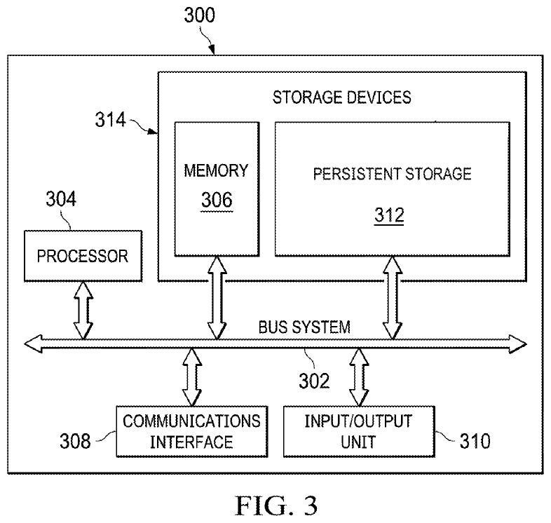

In some embodiments, the account registry 130 may facilitate a phone call between a sender's device and a recipient's device, for example, by hosting the phone call on a server of the account registry 130 after confirming the identities of the sender's device and the recipient's device. The account registry 130 may receive content from the devices connected to the network 160, including user-interface operations and voice commands. An app on the account registry may operate through platforms such as IOS™, ANDROID™, MAC™, LINUX™, and/or WINDOWS™. An exemplary server is shown and described in more detail in FIG. 3 that follows.

In some embodiments, the account registry 130 registers the devices 110, 120, 140, 150, for example, by storing in a reference table an IP address for each device in association with an identity of the device or the user of the device. Registering a device may be performed, for example, by a phone company before issuing the device to a user, by the user after receiving and booting the device, or by a third-party company (e.g., a bank) through the user's authorization. A user registering a device with an account registry may require, as an example, that the user present a government-issued ID card, submit to a biometric scan, or link the device to an online account (e.g., a work email or a social media account). By storing device-specific identification in a trusted database, the trusted database can look up the device sending a communication to confirm the identity of the sender.

In some embodiments, the account registry 130 stores encryption keys (e.g., public keys) in association with devices to permit device-specific encryption of communications that flow through the account registry 130 on their way between senders and recipients. Device-specific encryption may alleviate concerns of communication interceptions by unauthorized third-party devices.

A “recipient” is someone who receives something or who is intended to receive something (e.g., an electronic communication) from a sender. An electronic communication may include, for example, a text message, a call, or another electronic message. A recipient may receive, for example, a message or call through his or her electronic device. An intended recipient is a type of recipient who is the target of a communication, and who may ultimately receive the communication. In some instances, a single person may act as a recipient in one instance (when receiving a call or message), and operate as a sender in another instance (when sending a call or message). A single person may switch between roles depending on the operations he or she performs. Similarly, a single device may operate as a “recipient's device” in some instance, and as a “sender's device” in others.

A “sender” is someone who sends something or who intends to send something. A sender may send, for example, a message or a call through his or her electronic device. In some embodiments, a device may operate only as a sender's device or a recipient's device rather than being able to switch between roles. For example, in an embodiment where the sender is a bank and the receiver is a customer of the bank, the bank's device may be configured to only send calls and not to receive calls (or vice versa). In some embodiments, a device may perform functions of both sender and receiver.

The recipients and senders are types of users of the system. A “system,” as described in this specification, refers to one or more of the components of FIG. 1, alone or in combination with other components from FIG. 1. When a recipient or sender is required to provide biometric information, the recipient or sender must be a natural person (a human). Biometric confirmation relates to biology of a person (a person's physical appearance, fingerprint, etc.).

In some embodiments, each of the devices 110, 120, 140, 150 may communicate between each other. In some embodiments, each of the devices may receive confirmation from the account registry 130 of identities of other devices and users on the network when communicating with the other devices 110, 120, 140, 150. For example, communications from one device (a sender device 140, 150) may be routed to another device (a recipient device 110, 120) through the account registry 130, and the account registry 130 may authenticate the sender's device 140, 150 and/or the receiver's device 110, 120.

The first recipient device 110 is an electronic device that is operated by a recipient user. In some embodiments, the first recipient device 110 may receive an encrypted communication from a sender device 140, 150 through the account registry 130, over the network 160, and may decrypt the communication for presentation to a first recipient (i.e., the person using the first recipient device 110).

In some embodiments, the first recipient device 110 obtains biometric information from the first recipient prior to presenting the communication to the first recipient. For example, the first recipient device 110 may obtain a fingerprint from the first recipient or may perform a face-recognition scan (e.g., a three-dimensional infrared mapping of the user's face, using a front-facing camera) of the first recipient. The first recipient device 110 may confirm the identity of the first recipient by comparing the obtained biometric data with data stored on the first recipient device 110 (e.g., comparison with a prior face scan or prior fingerprint scan of the first recipient by mapping the new scan to the prior scan and determining an overlap or non-overlap).

The first recipient device 110 may have device specific encryption, such as through a device-specific key system (e.g., a public key and a private key). The first recipient device 110 may, for example, provide its public key to the account registry 130 for the account registry to use for encrypting data intended for the first recipient, then may decrypt communications from the account registry 130 using its private key (which may be stored in the memory of the first recipient device 110).

The first recipient device 110 may perform security functions at various layers, including at the application layer or at the operating-system (kernel) layer. For example, in some embodiments, the first recipient device 110 may store and compare biometric information locally at the kernel level of the device. In some embodiments, the first recipient device 110 may perform biometric comparison through an algorithm running in an application (e.g., an app provided by a bank), and may store biometric information in association with that application.

The second recipient device 120 is an electronic device that is operated by a recipient user. It may function similarly to the first recipient device 110. In some embodiments, a communication from a sender device 140 or 150 may be intended for two recipient devices 110 and 120 (e.g., a message intended for all members of a group, such as all customers who are receiving a new credit card that day), and the account registry 130 may send both recipient devices 110 and 120 the communication from the sender device 140 or 150.

The first sender device 140 is an electronic device that is operated by a sender user. It may have similar encryption functions and biometric-verification functions as the first recipient device 110. The second sender device 150 is an electronic device that is operated by a sender user. It may function similarly to the first sender device 140.

As illustrated, the first sender device 140 and the second sender device 150 communicate with the network 160, which is linked to the account registry 130 and the recipient devices 110, 120. Also illustrated is a possible connection between the first sender device 140 and the account registry 130. In some embodiments, the first sender device 140 may communicate directly with the account registry 130 without having to use a network to communicate between each other. For example, in some embodiments, the first sender device 140 may be integrated with the account registry 130. Integration of those devices may make sense, for example, if both devices are owned, operated, or managed by the same entity. For example, if a bank owns and operates both the account registry 130 and the first sender device 140, the bank could implement a computer (or other device) for its employee that has the account registry (e.g., server and database functionality for confirming the sender's identity and generating a digital signature for a recipient) running locally, and that allows the employee to also make calls, send messages, and/or present the employee's biometric information (e.g., the computer has a fingerprint reader). If the sender's device 140 and the account registry 130 are owned, operated, or managed by the same entity, the devices or their functionality may be merged.

As illustrated, the second sender device 150 does not have a direct connection with the account registry 130, but instead only connects to the account registry 130 through the network 160. In some embodiments, the second sender device 150 may communicate with the account registry 130 through the network 160 directly. In some embodiments, the second sender device 150 may communicate with the account registry 130 through the network 160 through the first sender device 140. For example, if the first sender device 140 is operated by a large bank having control over the account registry 130, and the second sender device 150 is operated by a small bank that uses the account registry 130 of the big bank, the second sender device 150 may connect to the account registry 130 through a connection to the first sender device 140 (e.g., a VPN or API).

FIG. 2 is a block diagram of a computing device usable in a system for secured communications. The computing device 200 is provided for illustration only. The devices 110, 120, 140, and 150 in FIG. 1 can have the same or similar configuration as the computing device 200 in FIG. 2.

Computing device 200 includes memory 202 storing instructions that can be executed by processor 204 for controlling the operation of the computing device 200. For example, the memory can store an operating system and one or more applications that can be executed by the processor 204. The memory 202 can include random access memory (RAM), Flash memory, and/or read-only memory (ROM).

I/O 206 is one or more input/output (I/O) devices of the computing device 200. Examples of I/O devices include, but are not limited to, a microphone, a speaker, a camera, a touch screen, or a keypad. I/O 206 enables a user to interact with the computing device 200 to communicate over a network, i.e., via a phone call, text message, email, or videoconference. In some embodiments, I/O 206 also includes I/O interfaces that provide the computing device 200 with communications paths with other devices, such as other client devices and peripherals.

The transceiver 208 provides a wireless communications capability with a network, such as network 160 in FIG. 1. Incoming signals are received by the transceiver 208 from the antenna 210 and processed by the receive (RX) circuity 212, which processes the signal and transmits the processed signal to an I/O device, such as a speaker, if the processed signal is for voice data. The processed signal can also be transmitted to the processor 204 for further processing before presentation to a user on another I/O device, such as a screen, if the processed signal is for other forms of data, such as web browsing data. Outgoing signals transmitted by the transceiver 208 from the antenna 210 are received from transmit (TX) circuitry 214. The TX circuitry 214 can receive voice data from a microphone, or other forms of outgoing data, such as web data, e-mail, or application data, from the processor 204.

The computing device 200 in FIG. 2 is depicted as a mobile phone, but the client device 200 can be any other conventional computing devices such as tablets, laptop computers, and desktop computers. For example, the transceiver depicted in the computing device 200 can be replaced by a network communications interface that can support wired or wireless communication over a user's home network.

FIG. 3 is a schematic diagram of a server 300 according to one or more illustrative embodiments. In some embodiments, the server 300 may be implemented in the account registry 130, and may perform one or more of the functions of the account registry 130.

Server 300 includes a bus system 302 that supports communication between at least one processor 304, at least one storage device 314, at least one communications interface 308, and at least one input/output (I/O) unit 310.

The memory 306 and a persistent storage 312 are examples of storage devices 314, which represent any structure(s) capable of storing and facilitating retrieval of information (such as data, program code, and/or other suitable information on a temporary or permanent basis). The memory 306 may represent a random-access memory or any other suitable volatile or non-volatile storage device(s). The persistent storage 312 may contain one or more components or devices supporting longer-term storage of data, such as a read only memory, hard drive, Flash memory, or optical disc.

The processor 304 may execute instructions that may be loaded into the memory 306. The processor 304 may include any suitable number(s) and type(s) of processors or other devices in any suitable arrangement. Example types of processors 304 include microprocessors, microcontrollers, digital signal processors, field programmable gate arrays, application specific integrated circuits, and discreet circuitry.

The communications interface 308 may support communications with other systems or devices. For example, the communications interface 308 could include a network interface card or a wireless transceiver facilitating communications over the network 102. The communications interface 308 may support communications through any suitable physical or wireless communication link(s).

The I/O unit 310 may allow for input and output of data. For example, the I/O unit 310 may provide a connection for user input through a keyboard, mouse, keypad, touchscreen, or other suitable input device. The I/O unit 310 may also send output to a display, printer, or other suitable output device.

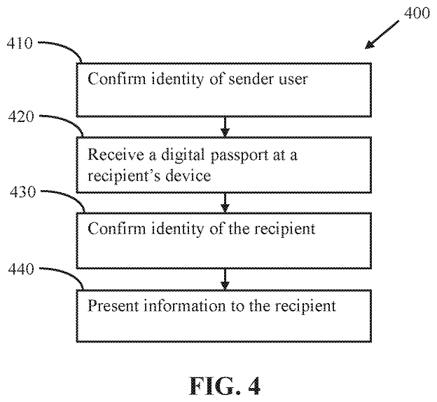

FIG. 4 is a flowchart 400 of steps for performing a secured communication according to one or more illustrative embodiments. Flowchart 400 may be performed by one or more of the components of the diagram 100 of FIG. 1. Flowchart 400 may, for example, be performed by the first recipient device 110, the account registry 130, and the first sender device 140. A secured communication may involve confirmation of identities of persons or devices involved in the communication, restriction of which persons or devices may send a communication, or restriction of which persons or devices may view a communication. For example, a secured communication may ensure that a recipient knows with confidence who is calling or texting him or her, may give a sender confidence that the text or call is only received by the person or device the text or call is intended for, and may encrypt various aspects of the communication throughout the transmission of the communication to prevent listening by unauthorized third-party devices.

The flowchart 400 begins at step 410 with confirming the identity of a sender user. Authenticating the sender's identity may be performed to reduce the chance of spoofing, fishing, or other types of malfeasance by a person requesting sensitive information.

In some embodiments, the sender's identity is confirmed by the sender's device. The sender's identity may be confirmed, for example, through biometric data (e.g., presenting the sender's finger or face for a scan by sensors on the sender's device). The sender's device may confirm the sender's identity, for example, by comparing the new biometric data with previously-obtained sensor data. In some embodiments, the sender's identity is confirmed by an account registry. For example, the account registry may determine an IP address or other address or data that is unique to the sender's device, compare that device-identification data with a reference table, and confirm that the sender is listed in the table. The table at the account registry may be used, in some embodiments, for more than checking that the sender's device is registered: for example, it may check that a name associated with the sender's device in the table matches the name that the sender is attempting to use for the communication to the recipient. In some embodiments, the sender's identity is confirmed at both the sender's device and the account registry.

Confirming the sender's identity may be performed in response to a sender's request, on the sender's device, to contact a recipient. For example, a sender may attempt to initiate a call or to send a text to a recipient. At that point, or at some point soon before or soon after, the sender's device may request that the sender provide biometric data to the sender's device. Then, the sender's device may route the message or call to an account registry, and the account registry may authenticate the device before passing the message or call to the recipient. Before passing a call or message to a recipient, an account registry might also add encryption, such as encryption of its authentication of the sender's identity. The receiver's device may need to decrypt the communication from the account registry, and authenticate the receiver, prior to viewing a message or answering a call from the sender.

The flowchart 400 continues to step 420 with receiving a digital passport at a recipient's device. A digital passport is a communication that conveys an authentication of a sender's identity. A digital passport may be generated by an account registry and sent from the account registry to a recipient's device. A digital passport may be encrypted: for example, by an account registry using a public key associated with the intended recipient. An account registry may generate a digital passport as part of the process of authenticating the identity of the sender: for example, the account registry may receive a communication from a sender's device (e.g., an attempt to call, email, or text the recipient that is routed through the account registry), may look the up the IP address of the sender's device in a reference table, may confirm that the IP address is already in the reference table, and may send the communication through to the recipient's device in combination with a seal of approval originated from the account registry. A seal of approval is an indication that the sender has passed the screening process of the account registry, which may be represented by an addition to the communication directly stating that the message is verified (e.g., “verified sender”), or indirectly indicating the verification (e.g., based on the communication received by the recipient's device coming from an IP address of the account registry).

In some embodiments, a digital passport may be a replica of the communication sent from the sender's device that is sent from the account registry. In some embodiments, the digital passport includes a communication from a sender user, an identification of the sender user, and an authentication of the identity of the sender user.

If the communication is a text message, the digital passport may include the text message (e.g., “the code to activate your new credit card is 555”), the sender's name (e.g., “Wells Fargo”), and an indication that the message is being forwarded from the account registry (a known and trusted intermediate device). In some embodiments, the message from the recipient is encrypted by the sender's device. If the communication is a call, the digital passport may include a sender name (e.g., “Chase Bank”), an authentication of the sender (e.g., an official seal of the bank or a verification check mark), and a reason for the call (e.g., “Confirming a $500 payment).

In some embodiments, the digital passport is encrypted, and some or all of its contents may only be viewed by the recipient after decryption and/or authentication by the recipient and the recipient's device. In some embodiments, an encrypted digital passport allows the recipient's device to see, without decryption, that the encrypted digital passport is being sent from the account registry; but not see the contents of the message and/or the name of the sender. In some embodiments, the encrypted digital passport can be decrypted only by a specific recipient device (e.g., through information only known by the recipient's device, like a private key). In some embodiments, the recipient's device decrypts the message prior to authenticating the recipient. In some embodiments, the recipient's device initiates decryption only after the identity of the recipient is confirmed by the recipient's device (e.g., through biometric data and biometric sensors). In some embodiments, a recipient's device can decrypt an encrypted digital passport without any input from the recipient, and then may present information from the digital passport to the recipient upon a confirmation that the recipient has recently, or subsequently, been authenticated through a biometric scan of the recipient's device.

In some embodiments, a call from a sender that is intended for a recipient may result in a communication to the recipient that comprises both the call and a message (e.g., text or audio). The message may be, for example, an explanation for why the sender is attempting the call, or a subject matter the sender wants to discuss on the call. The message may be obtained, for example, through an audio prompt to the sender, after the sender initiates the call, that the sender responds to with audio. An audio prompt may be generated locally by the sender's device or may be generated by the account registry. The message may also be typed by the sender, or may be automated by the sender's device or the account registry. For example, if the sender is a bank, and the recipient is a customer of the bank, the account registry may be able to deduce (e.g., through a reference table) that the reason for the call is to discuss the recipient's account at that bank. The account registry may send the recipient the message to help the recipient determine whether to accept the call.

The flowchart 400 continues to step 430 with confirming the identity of the recipient. Authenticating the recipient may be performed to reduce the chance that sensitive information is obtained by an incorrect device or an incorrect user (e.g., in case the recipient's device is stolen or the communication is obtained by a third-party device as part of a man-in-the-middle attack).

In some embodiments, the recipient's identity is confirmed by the recipient's device. Confirming the identity of the recipient at the recipient's device may be similar to confirming the identity of the sender at the sender's device. In some embodiments, the recipient's identity is confirmed by an account registry. Confirming the recipient's identity by the account registry may be similar to confirming the sender's identity at the account registry. In some embodiments, confirming the identity of the recipient by the account registry involves checking a reference table stored by the account registry for an electronic address or username of the recipient, and/or encrypting the communication intended for the recipient's device with an algorithm that can only be decrypted by the recipient or the recipient's device. In some embodiments, confirming the identity of the recipient by the recipient's device involves a biometric scan of the recipient using sensors of the recipient's device and confirming the biometric scan through comparison with prior biometric scans of the recipient. In some embodiments, the recipient's identity is confirmed at both the recipient's device and the account registry.

Confirming the recipient's identity may be performed, for example, in response to (and soon after) receiving the encrypted digital passport, in response to (and soon after) decrypting the digital passport, prior to receiving the encrypted digital passport, or in response to the recipient requesting to view information from the digital passport or to accept a call from the sender.

The flowchart 400 continues to step 440 with presenting information to the recipient.

Presenting information to the recipient may be performed, for example, immediately in response to the recipient requesting the view information from the digital passport or to accept a call from the sender. Presenting information to the recipient may be performed, for example, immediately after authenticating the recipient's identity at the recipient's device (e.g., biometric data of the recipient). Presenting information to the recipient may be performed in steps: for example, that the sender has been authenticated may be conveyed to the recipient based on the communication coming from the account registry, which may be depicted to the recipient prior to authentication or decryption; the sender's name may be depicted after decryption but before the recipient has verified his or her identity (e.g., biometrics); and the contents of the communication from the sender may be withheld until both decryption and recipient verification has been performed.

In some embodiments, a name of a sender, a message, or part of a message, may be presented to the recipient to help the recipient decide whether or how urgently to submit to biometric scanning for a communication. For example, the recipient's device might show that Wells Fargo (sender) is calling about a possibly fraudulent credit card charge (message), but the recipient will not be able to answer the call until the recipient has verified his or her identity.

Presenting information to the recipient may be performed, for example, by displaying on a screen of the recipient's device a message (e.g., a text message, an email, a call request, or information about the subject matter for a call), a name of a sender, or an authentication of a sender. Presenting the information may include a notification on the recipient's device: for example, by playing a noise over a speaker of the device or causing a vibration of the device.

In some embodiments, the information presented to the user is an indication that a sender is attempting to call the recipient. In some embodiments, the information presented includes a reason for a call; a subject matter for a call; or a text message, email message, or other type of message conveying private information.

In some embodiments, the presenting the information to the recipient may be conveyed to the account registry or to the sender. For example, the recipient's device may transmit a read receipt (an indication that the communication has been presented to the recipient) to the account registry or to the sender. The account registry may convey a read receipt to the sender. In some embodiments, upon the presenting the information, if the information includes an indication that the sender is trying to call the recipient, the recipient may be presented with an option to accept the call: in such embodiments, the recipient's selection of an option to accept the call may be conveyed to the account registry or to the sender, and that acceptance of the call can be proof that the recipient viewed the information.

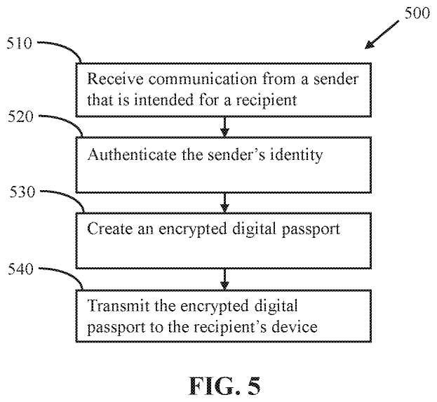

FIG. 5 is a flowchart 500 of steps performed by an account registry in facilitating a secured communication according to one or more illustrative embodiments. The communications may be encrypted: for example, being encrypted by the account registry or encrypted prior to being received by the account registry (e.g., by the sender's device), or both. The communication may be between a sender's device and a recipient's device. The communication may involve sensitive information, such as the name of the sender, or the information conveyed by the sender (e.g., bank info, medical info, classified info, or trade secret info).

The flowchart 500 begins at step 510 with receiving a communication from a sender that is intended for a recipient. The communications may be audio calls, video calls, text messages, emails, or other kinds of electronic communications. In some embodiments, the communications include a combination of message types, such as an audio call in combination with a text-based message. The text message may include, for example, a subject matter for the call, and may be generated by the sender's device or by the account registry.

In some embodiments, the communication received from the sender's device is encrypted. In some embodiments, the account registry decrypts the message prior to sending the message to the recipient's device. In some embodiments, the account registry sends the message to the recipient's device without first decrypting it. In some embodiments, the sender's device will not allow a communication to be sent to the account registry until the sender's identity has been confirmed by the sender's device. Confirming the sender's identity may occur, for example, in an application that is linked to the account registry, or may be performed at the operating-system level of the sender's device.

The communication from the sender may include an identification of the source of the message (e.g., the IP address of the sender's device). The communication from the sender may identify an intended recipient (e.g., the recipient's phone number or email address).

The flowchart 500 continues to step 520 with authenticating the sender's identity. The account registry may authenticate the sender's identity, for example, by comparing an identified source of the message with a reference table stored at the account registry. The account registry may, for example, check that an IP address (or other electronic address) of the sender's device is listed in a reference table, or that the sender's name in the message matches the name linked to the sender's IP address in the reference table. In some embodiments, the reference table includes an encryption key associated with at least one of the sender's device or the recipient's device. Including encryption keys (e.g., public keys) in association with the sender or recipient may allow the account registry to encrypt or decrypt messages between the sender and recipient.

The flowchart 500 continues to step 530 with creating an encrypted digital passport. Creating an encrypted digital passport involves creating a digital passport and encrypting the digital passport. The digital passport includes an authentication by the account registry of the sender's identity. Encryption prevents sensitive information from being viewed by unwanted parties or unauthorized devices. Some or all of the information in the digital passport may be encrypted, and parts of the digital passport may be encrypted using different algorithms than other parts. In some situations, the name of the caller, the reason for the call (e.g., conveyed as a message), or the content of a text message may be sensitive information. The digital passport may also include, in combination with the identity and authentication of the identity of the sender, a communication from the sender. The communication from the sender may be encrypted by the sender's device and/or the account registry.

In some embodiments, the account registry creates a digital passport by combining the communication (e.g., a message or call request), the sender's identity, and the authentication of the sender's identity. In some embodiments, the authentication of the sender's identity may include a “yes” or “no” indicator as part of the digital passport.

In some embodiments, the account registry encrypts a digital passport by using an encryption key associated with a device of the recipient user. The account registry may do that by receiving a public key of the registered devices at the time of their registration with the account registry, associating the public key with the device ID (e.g., the IP address) of the device in a reference table, and referencing that reference table in the process of encrypting the digital passport.

The flowchart 500 continues to step 540 with transmitting the encrypted digital passport to the recipient's device. The account registry may transmit the encrypted digital passport, for example, over the Internet or through a cellular network (e.g., AT&T™, T-MOBILE™, or VERIZON™). Upon receiving the encrypted digital passport, the recipient's device may notify the recipient. The recipient's device may decrypt the digital passport, authenticate the recipient, and present information from the digital passport to the recipient (e.g., the contents of a message or an indication that a call is incoming).

In some embodiments, the recipient's device, after receiving, decrypting, and viewing the message, sends a confirmation to the network. For example, the recipient's device could send a read receipt to the account registry, to the sender's device, or both. In some embodiments, if the sender's message relates to an attempt to call the recipient, the confirmation from the recipient may be an acceptance of the call. In some embodiments, the recipient is only permitted to accept the call after having viewed the message. In some embodiments, the recipient's device may send a confirmation that the recipient viewed the message, and a separate transmission accepting a call from the sender.

In some embodiments where the sender attempts to call the recipient, and the recipient authorizes the call after the sender and recipient's identities are verified, the account registry may facilitate the call. Facilitating the call may involve hosting the call on a server of the account registry such that the parties to the call know the call is between verified people. Facilitating the call may involve allowing the recipient's device to accept a call from the sender's device such that the call is transmitted between the recipient and sender devices without going through the account registry.

In some embodiments, the account registry may receive a confirmation from the recipient's device, and may send that confirmation to the sender's device, or may use that confirmation in determining to facilitate a call between the recipient and sender devices. For example, a confirmation may include a read receipt or an authorization to accept a call.

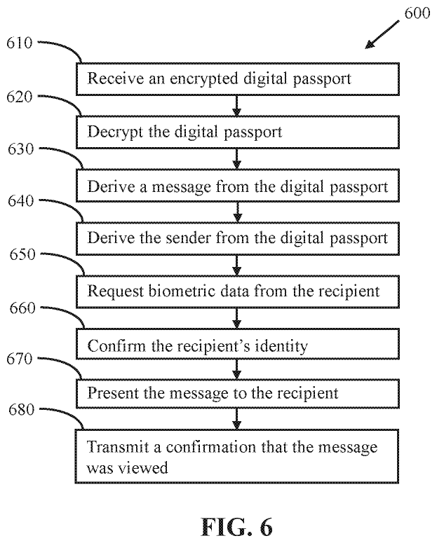

FIG. 6 is a flowchart 600 of steps performed by a recipient's device according to one or more illustrative embodiments. Flowchart 600 includes receiving, decrypting, and presenting information to a recipient. A recipient's device may be, for example, a smart phone or laptop computer.

The flowchart 600 begins at step 610 with receiving an encrypted digital passport. In some embodiments, the digital passport includes a message from a sender user, an identification of the sender user, and an authentication of the identity of the sender user. In some embodiments, the message includes a subject-matter description for a call from the sender user to the recipient user. In some embodiments, the message is not associated with a call but is instead an independent communication (e.g., email or text message).

In some embodiments, receiving an encrypted digital passport includes performing a background check that the sender is authorized or verified (e.g., by the account registry). The recipient's device may do that, for example, at the kernel level by checking information in the digital passport. The recipient's device may confirm that the digital passport is from a verified user (e.g., based on a certification from an account registry) prior to notifying the recipient that it received the digital passport. The recipient's device may determine that the sender is authorized based on, for example, a tag included in the digital passport by the account registry that indicates a verification by the account registry.

In some embodiments, if a sender attempts to call a recipient, the recipient's device rings only after the recipient's device verified that the call was verified by the account registry. Similarly, in some embodiments, a message may be presented to a recipient only after the source of the message is verified by the recipient's device. In some embodiments, the recipient's device may present to the recipient that a call or message is from a verified user through an indicator on the screen (e.g., a green light or indicator).

In some embodiments, the digital passport is a data packet. In some embodiments, authentication of the sender may include an official seal of the sender (e.g., an official company logo, or a picture of a person), an image of the sender (e.g., a headshot or selfie), or a verification mark (e.g., a check mark) to be presented to the recipient.

The flowchart 600 continues to step 620 with decrypting the digital passport. In some embodiments, the recipient's device may decrypt the digital passport using a decryption algorithm that is specific to the recipient's device. In some embodiments, the decrypting the encrypted digital passport is performed without human input. For example, the recipient's device may decrypt the received digital passport using internal algorithms prior to notifying the recipient that the message was received. The recipient's device may also perform other functions prior to notifying the recipient of the incoming communication, such as verifying the source of the communication (e.g., if the source of the communication is not verified, the recipient's device may determine that the recipient should not be notified, and could proceed with not notifying the recipient).

The flowchart 600 continues to step 630 with deriving a message from the digital passport. Deriving a message from the digital passport may include, for example, determining a reason for a call, a subject matter for a call, or a content of a text message. The message may be derived, for example, by identifying the message in the digital passport, or separating it from other information in the digital passport. In some embodiments, the sender may transmit an encrypted message to the account registry, and the account registry may transmit that encrypted message to the recipient's device as is (still encrypted, but with other information such as a verification tag in the data packet), with an additional layer of encryption, or with a different layer of encryption (i.e., by decrypting then re-encrypting the message).

The flowchart 600 continues to step 640 with deriving a sender from the digital passport. Deriving a sender from the digital passport may include, for example, parsing the digital passport to identify the name or other identification of the sender. For example, if the digital passport is received as a single data packet, part of the packet may include the sender's name. The recipient's device may determine from the packet who the sender is.

In some embodiments, the recipient's device presents the identity of the sender user to the recipient prior to receiving biometric data of the recipient. In some embodiments, the recipient's device presents the identity of the sender user to the recipient only after authenticating the recipient. An identity of the sender may assist the recipient in deciding whether to view or accept the communication, for example.

The flowchart 600 continues to step 650 with requesting biometric data from the recipient. Biometric data may include, for example, a fingerprint or face scan. A device may request biometric data, for example, with words or symbols indicating that a scan is required. In some embodiments, if a device is already unlocked through a biometric scan, the device may elect to not request an additional scan; in other embodiments, an additional scan may be required.

The flowchart 600 continues to step 660 with confirming the recipient's identity. Confirming the recipient's identity may involve, for example, comparing newly received biometric data with biometric data that is stored on the recipient's device.

The flowchart 600 continues to step 670 with presenting the message to the recipient. In some embodiments, the recipient's device may present the message immediately in response to authenticating the recipient. The message may include, for example, a reason for a call, a subject matter for a call, or a text message. A message may be presented, for example, on a display screen of a recipient's device or read through an audio output (e.g., speakers, headphones) of the recipient's device.

In some embodiments, the presenting the message comprises presenting the recipient with an option to authorize a call from the sender.

The flowchart 600 continues to step 680 with transmitting a confirmation that the message was viewed. A confirmation that the message was viewed may include, for example, a read receipt, a response, or an acceptance of a call.

In some embodiments, after transmitting the confirmation that the recipient viewed the message, the recipient's device may receive, from the recipient user, an authorization to initiate a phone call with the sender's device; and may initiate the phone call in response to the authorization. In some embodiments, transmitting the confirmation that the recipient user viewed the message is accomplished by transmitting the authorization of the call or by initiating the call.

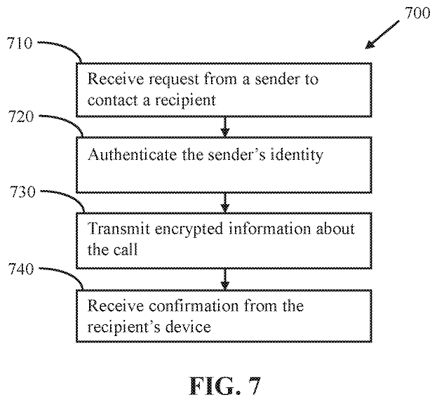

FIG. 7 is a flowchart 700 of steps performed by a sender's device in facilitating a secured call according to one or more illustrative embodiments. Flowchart 700 is based on the communication being a call, but many of the principles may apply equally to communications involving text messages, emails, or other communication mechanisms.

The flowchart 700 begins at step 710 with receiving a request from a sender to contact a recipient. The call could be, for example, a person calling a grandparent, a bank calling a customer, or a customer calling a bank. The request may be made, for example, through a third-party application on a smart phone, or through a smart phone's built-in phone-calling application. In embodiments with text messages, emails, or video calling, analogous applications may be used.

If an account registry is managed by a smart phone company (e.g., APPLE™ or GOOGLE™), then routing a call from that company's phone (e.g., IPHONE™ running IOS™ operating system, or PIXEL™ running ANDROID™ operating system) to the company's account registry could be performed without requiring third-party routing. For example, the routing of a call from a user's device to the account registry could be performed at the operating-system level. Routing the call through the account registry could be an option provided by the smart phone company that could be toggled by the user, or could be automatic and applied to all devices. So too for other products originating from (or having operating systems originating from) the owner, operator, or manager of the account registry (e.g., MAC™ computers running MACOS™ operating system, or CHROMEBOOKS™ running CHROMEOS™ operating system).

In some embodiments, if an account registry is managed by a bank, the bank's customers could install an app on their phones to route their calls through the account registry.

The request to contact the recipient may include an identification of the recipient's contact information (e.g., phone number or email), a request to initiate an audio-based phone call with the recipient, a reason for the call, or biometric data of the sender. For example, to make a call to a recipient, a sender's device (or the account registry) may require the sender to prove his or her identity through a biometric scan. Upon selecting a recipient to call, the sender may be prompted to provide a reason for the call prior to the call request being sent to the recipient, or while the call request is being sent to the recipient.

The flowchart 700 continues to step 720 with authenticating the sender's identity. The sender's device may confirm the sender's identity, for example, by comparing the received biometric data with biometric data that is stored on the sender's device. In some embodiments, the sender's device may authenticate the sender's identity through non-biometric mechanisms, such as by entering a memory-based password, an answer to a security question, a code from a random-code generator of an authentication app on another device, or from another form of identity verification or two-factor authentication.

The flowchart 700 continues to step 730 with transmitting encrypted information about the call. Information about the call may include, for example, the sender's identity, the recipient's identity, the sender's reason for the call, or subject matter for reference in the call (e.g., the recipient's bank account number).

The flowchart 700 continues to step 740 with receiving confirmation from the recipient's device. Confirmation may include, for example, a read receipt or an indication that the recipient accepts the call.

The above detailed description includes exemplary embodiments, some of which are illustrated by the figures. The term “may” in relation to a feature described in this specification indicates that the feature can be present in some embodiments, and can be omitted in other embodiments: “may” is used to describe an example that might be present in some embodiments, and “may” is non-exhaustive. If an optional feature includes multiple components, each component can be independently included in an embodiment unless the specification indicates that two or more of the components must be coupled together. The term “or” in a string of two or more options means “and/or” unless the context indicates otherwise: the term “or”—when joining a string of two or more options—indicates that a combination of one or more of the options can be selected for an embodiment.

Although embodiments of this disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

While novel aspects of this disclosure have been particularly shown and described with reference to preferred embodiments, it will be understood by those skilled in the art that various changes in form and detail may be made therein without departing from the spirit and scope of this disclosure. The inventors expect skilled artisans to employ such variations as appropriate, and the inventors intend that the novel aspects of this disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by this disclosure unless otherwise indicated herein or otherwise clearly contradicted by context.

1. A method performed by a device of a recipient user, the method comprising:
receiving an encrypted digital passport from an account registry, wherein the digital passport includes a message from a sender user, an identification of the sender user, and an authentication of the identity of the sender user;
decrypting, using a decryption algorithm that is specific to the recipient's device, the encrypted digital passport;
deriving, from the decrypted digital passport, the message from the sender user;
deriving, from the decrypted digital passport, the authentication of the identity of the sender user;
requesting biometric data from the recipient user;
confirming the identity of the recipient user by comparing the received biometric data with biometric data that is stored on the recipient's device;
presenting, based on the confirmation of the identity of the recipient user, the message from the sender user; and
transmitting a confirmation that the recipient user viewed the message.

2. The method of claim 1 wherein the method further comprises presenting, to the recipient user, the identity of the sender user prior to the receiving the biometric data.

3. The method of claim 1 wherein the method further comprises presenting, to the recipient user, based on the confirmation of the identity of the recipient user, the identity of the sender user.

4. The method of claim 1, wherein:
the communication that the account registry received from the sender's device was encrypted and included the message;
the account registry, upon receiving the communication from the sender's device, confirmed the authenticity of the sender's device using a reference table;
the account registry, based on the confirming the authenticity of the sender's device, generated the decrypted digital passport, which included the message and the sender's identity; and
the account registry, after generating the digital passport, encrypted the digital passport using an encryption algorithm that could be decrypted by the recipient's device.

5. The method of claim 4, wherein the account registry, upon receiving the encrypted message from the sender's device, decrypted the message.

6. The method of claim 1, wherein:
the sender user is a bank;
the recipient user is a natural person and a customer of the bank; and
the account registry is managed and operated by the bank.

7. The method of claim 1, wherein:
the sender user and the recipient user are natural persons; and
the account registry is managed and operated by a smartphone company.

8. The method of claim 1, wherein:
the account registry stores an encryption key associated with the recipient user in a database.

9. The method of claim 1, wherein the sender's device, prior to sending the communication to the account registry, confirmed the sender user's identity through biometrics of the sender user that were obtained by sensors of the sender's device and were compared with biometric data stored on the sender's device.

10. The method of claim 1, further comprising, after the transmitting the confirmation that the recipient user viewed the message:
receiving, from the recipient user, an authorization to initiate a phone call with the sender's device; and
initiating the phone call.

11. The method of claim 1 wherein the decrypting the encrypted digital passport is performed without human input.

12. The method of claim 1 wherein:
the message includes a subject-matter description for a call from the sender user to the recipient user;
the presenting the message comprises presenting the recipient user with an option to authorize the call;
the method further comprises receiving, from the recipient user, an authorization of the call; and
the transmitting the confirmation that the recipient user viewed the message comprises at least one of transmitting the authorization of the call or initiating the call.

13. A method performed by an account registry that conveys encrypted messages, the method comprising:
receiving, from a device of a sender, a message, an identity of the sender, and an indication of a recipient user as a target for the message;
authenticating the sender's identity using a reference table at the account registry;
combining the message, the sender's identity, and the authentication of the sender's identity into a digital passport;
encrypting the digital passport using an encryption key associated with a device of the recipient user; and
transmitting, to the recipient's device, the encrypted digital passport.

14. The method of claim 13 wherein:
the message received from the sender's device is encrypted; and
the method further comprises decrypting the message.

15. The method of claim 13 further comprising:
receiving, from the recipient's device, an indication that the recipient viewed the message;
receiving, from the recipients device, an authorization to initiate a phone call with the sender user; and
facilitating a phone call between the sender's device and the recipient's device.

16. The method of claim 13 wherein the reference table includes an electronic address of the sender's device.

17. The method of claim 13 wherein the reference table includes an encryption key associated with at least one of the sender's device or the recipient's device.

18. A method performed by a device of a sender user, the method comprising:
receiving, from the sender user, a request to initiate a call with a recipient user, a reason for the call, and biometric data of the sender user;
confirming an identity of the sender user by comparing the received biometric data with biometric data that is stored on the sender's device;
encrypting the reason for the call;
based on the confirming the identity of the sender user, transmitting the encrypted reason for the call and an identification of the recipient user to an account registry;
receiving, from a device of the recipient user, a confirmation that the recipient user viewed the reason for the call.

19. The method of claim 18 wherein the account registry:
authenticates the sender's identity using a reference table and an electronic address of the sender's device;
combines the reason for the call, the sender's identity, and the authentication of the sender's identity into a digital passport;
encrypts the digital passport using an encryption key associated with the recipient's device; and
transmits, to the recipient's device, the encrypted digital passport.

20. The method of claim 18 wherein the recipient's device:
decrypts, using a decryption algorithm that is specific to the recipient's device, the encrypted digital passport;
derives, from the decrypted digital passport, the reason for the call;
derives, from the decrypted digital passport, the authentication of the identity of the sender user;
requests biometric data from the recipient user;
upon receiving biometric data from the recipient user, confirms the identity of the recipient user by comparing the received biometric data with biometric data that is stored on the recipient's device;
presents, based on the confirmation of the identity of the recipient user, the reason for the call; and
transmits, to the sender user's device, a confirmation that the recipient user viewed the reason for the call.
